(19) United States
(12) Patent Application Publication
(10) Pub. No.: US 2011/0297138 A1
(43) Pub. Date: Dec. 8, 2011

(54) COVER FOR USE WITH A FURNACE DURING A HEATING OPERATION

(76) Inventors: Harry E. Laughery, Monroeville, PA (US); Werner Niehaus, Reynoldsburg, OH (US)

(21) Appl. No.: 12/796,201

(22) Filed: Jun. 8, 2010

(51) Int. Cl. F24C 1/00; B23P 17/04

(52) U.S. Cl. 126/58; 29/401.1

(57) ABSTRACT

An improved cover for use in conjunction with a furnace in performing a heating operation on a workpiece includes a support and an emission apparatus. The emission apparatus advantageously is in the form of a ceramic layer that has an emissivity value greater than that of the surface to which the emission layer is applied. In other embodiments, an emission layer can be applied to both the heated and non-heated surfaces of a cover. The emission apparatus reduces costs due to one or more factors such as a less costly material requirement, a reduced heating requirement, and an increased service life.

### BACKGROUND

1. Field

The disclosed and claimed concept relates generally to heating operations performed with a furnace, and more particularly, to an improved cover for a workpiece that is used during such a heating operation.

2. Background Information

Numerous types of heat treatment operations are known for use in conjunction with metals that have been worked such as through rolling, extrusion, and the like. Heat treatment operations are employed in operations including annealing, normalizing, and tempering, among others. Such heating operations desirably occur within a non-oxidizing environment, which can be one in which oxygen has been consumed or removed or can be an otherwise inert or non-reactive environment. In order to maintain such a non-reactive environment, a cover is typically employed within the interior of a furnace, with the object that is undergoing the heat treatment operation being disposed within the interior of the cover.

Such a heat treatment operation involves heating the furnace which heats the cover which, in turn, heats the workpiece. The cover typically will be disposed on a layer of refractory materials that are situated on the ground or on a floor of a factory. The workpiece undergoing the heat treatment operation is likewise disposed on the layer of refractory material but is enclosed within the cover.

While such covers have been generally effective for their intended purposes, such covers have not, however, been without limitation. Due to the high temperatures involved in such heat treatment operations, as well as the duration of such heat treatment operations, such covers typically are formed out of costly materials that are suited to withstand such high heat for extended lengths of time. For example, such covers may be formed from Inconel or other stainless steel formulations having a relatively high proportion of nickel. Such covers typically may be of a cylindrical configuration six to ten feet in diameter and ten to twenty feet in height, or of a polyhedron configuration six to ten feet wide, twelve to thirty-five feet long, and ten to twenty feet high. Thus, due to their large size and the costly nature of the material out of which such covers are formed, the cost to manufacture such covers is extremely high.

Moreover, the lifespan of such covers often is relatively limited due to the destructive environment in which many such covers are used. Many furnaces are fired with fossil fuels such as natural gas, oil, etc., which require oxygen for combustion, and with the result that the surface of the cover that is exposed to such combustion will become oxidized or otherwise affected and will fail mechanically due to breaching of the material due to corrosion alone or due to corrosion in conjunction with slumping of the material due to its weight.

It thus would be desirable to provide an improved cover that addresses these and other concerns associated with other covers known in the art.

### BRIEF DESCRIPTION OF THE DRAWINGS

A further understanding of the disclosed and claimed concept can be gained from the following Description of the Preferred Embodiments when read in conjunction with the accompanying drawings in which:

FIG. 1 is a perspective view of a first embodiment of an improved cover in accordance with the disclosed and claimed concept;

FIG. 2 is a partially cut away view of a furnace within which is disposed the cover of FIG. 1, also cut away, as well as a workpiece disposed within an interior of the cover;

FIG. 3 is a sectional view as taken along Line 3-3 of FIG. 1;

FIG. 3A is a view similar to FIG. 3, except depicting a sectional view of an improved cover in accordance with a second embodiment of the disclosed and claimed concept;

FIG. 3B is a view similar to FIG. 3, except depicting a sectional view of an improved cover in accordance with a third embodiment of the disclosed and claimed concept; and

FIG. 3C is a view similar to FIG. 3, except depicting a sectional view of an improved cover in accordance with a fourth embodiment of the disclosed and claimed concept.

Similar numerals refer to similar parts throughout the specification.

### DESCRIPTION OF THE PREFERRED EMBODIMENTS

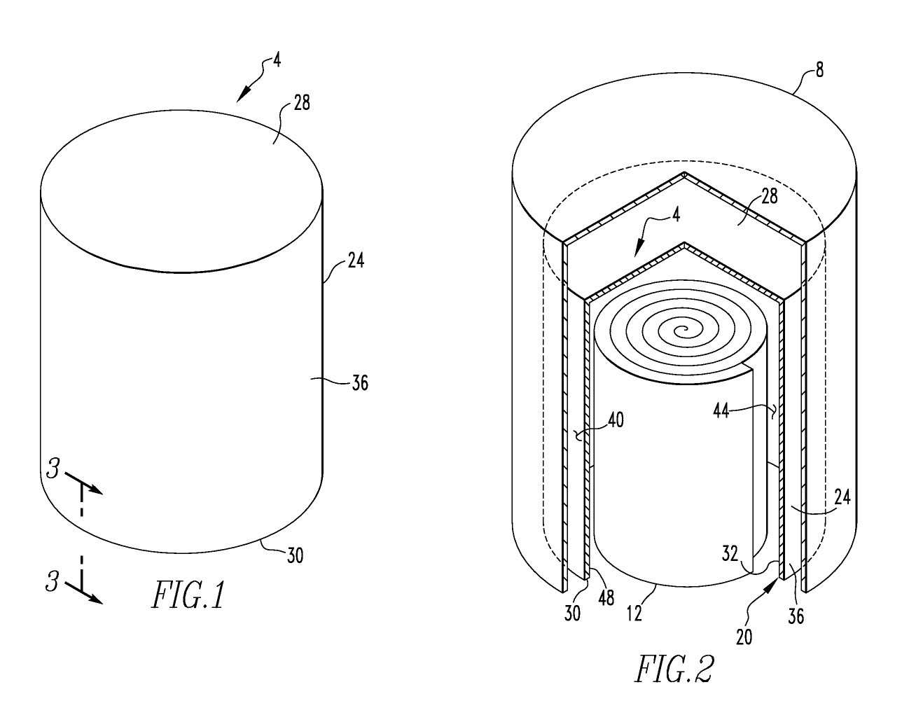

An improved cover 4 in accordance with a first embodiment of the disclosed and claimed concept is indicated generally in FIG. 1. As can be understood from FIG. 2, the cover 4 is disposed within a furnace 8 and encloses therein a workpiece 12 during a heating operation performed on the workpiece 12 by the furnace 8. The exemplary cover 4 is of a hollow, generally cylindrical configuration, but it is understood that numerous other shapes can be employed in making the cover 4 without departing from the present concept.

As can be understood from FIGS. 1-3, the cover 4 can be stated as comprising a support 16 and an emission apparatus 20. The support 16 is typically formed of a metal such as stainless steel and typically is of a relatively high nickel content. For example, the support 16 can be formed of Inconel, 309 stainless steel, 316 stainless steel or other appropriate material. The emission apparatus 20 of the first embodiment is in the exemplary form of a ceramic coating disposed on the support 16, as will be set forth in further detail below.

As can be understood from FIGS. 1 and 2, the support 16 is of a hollow, generally cylindrical configuration and comprises a cylindrical lateral wall 24 and a circular upper wall 28. It is understood that non-cylindrical shapes can be employed in forming the cover 4 without departing from the present concept. The support 16 is open at an end 30 opposite the upper wall 28.

As can be understood from FIG. 2, during a heating operation performed by the furnace 8 on the workpiece 12, the workpiece 12 is disposed within an interior 44 of the cover 4, and the cover 4 is disposed within an interior 40 of the furnace 8. Heat is supplied within the interior 40 of the furnace between the furnace 8 and the cover 4. The cover 4, the furnace 8, and the workpiece 12 are typically all disposed on a layer of refractory brick or other heat-resistant material that is disposed on the ground or on a floor of a factory, it being noted that the layer of refractory material is not expressly depicted herein for reasons of clarity.

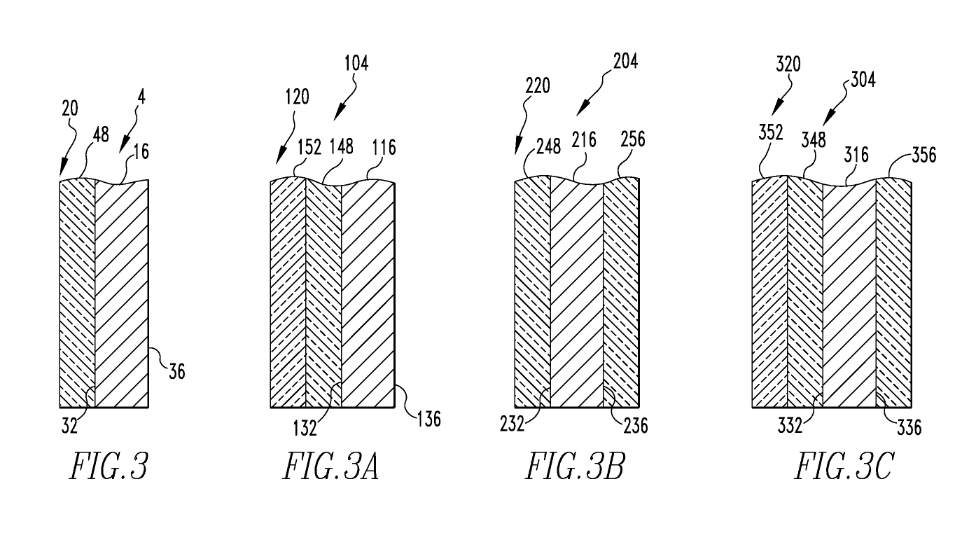

As can be understood from FIG. 3, the cover 4 includes a first surface 32 that is adjacent and faces generally toward the workpiece 12. The cover 4 further includes a second surface 36 opposite the first surface 32 that is disposed adjacent and faces generally toward the interior 40 of the furnace 8. The first and second surfaces 32 and 36 each extend across both the lateral wall 24 and the upper wall 28.

In the first embodiment of the cover 4, the emission apparatus 20 is in the form of an emission layer 48 disposed on the first surface 32 of the support 16. By way of example, the emission layer 48 may be a coating of a product known as ITC 213 manufactured by International Technical Ceramics, Inc., of Jacksonville, Fla., USA, or other appropriate material. The first surface 32 of the support 16 has an emissivity value that is dependent upon a number of factors such as the material from which the support 16 is formed, the degree of polishing or oxidation on the first surface 32, the geometry of the support 16, and other factor. Advantageously, however, the emission layer 48 has an emissivity value that is relatively greater than the emissivity value of the first surface 32.

As is generally understood, the emissivity of a surface of a material can be characterized as the proportion of radiation that occurs from the surface at a given temperature compared with what would be radiated from an ideal black body at the same temperature. At a given temperature, a surface having a relatively higher emissivity will radiate more heat than another surface having a relatively lower emissivity. As such, since the emission layer 48 has an emissivity value greater than the emissivity value of the first surface 32, the cover 4 with its emission apparatus 20 will radiate more heat into the workpiece 12 at a given temperature of the furnace 8 than could be radiated into the workpiece 12 by the support 16 by itself, i.e., in the absence of the emission apparatus 20.

Accordingly, the furnace 8 can advantageously be operated at a relatively lower temperature when using the cover 4 with its emission layer 48 since the emission layer 48 radiates into the workpiece 12 a desired amount of heat at a relatively lower temperature of the furnace 8 than would be required in the absence of the emission layer 48. This advantageously saves money due to the reduced heating requirement of the furnace 8. Moreover, and further advantageously, since the furnace 8 can be operated at a relatively lower temperature, the support 16 can itself be formed of a relatively less costly material than would otherwise be required in the absence of the emission layer 48. For example, whereas the support 16 might otherwise have been required to be formed from Inconel, the support 16 when used in conjunction with the emission layer 48 can instead be formed of 309 stainless steel, which is relatively less costly. Thus, the addition of the emission apparatus 20 to the support 16 provides great cost savings.

In a second embodiment of the disclosed and claimed concept, a cover 104 is depicted generally in FIG. 3A and includes an emission apparatus 120 that comprises an emission layer 148 on the first surface 132 of the support 16 and advantageously further comprises a secondary emission layer 152 disposed on the emission layer 148. The emission layer 148 may be formed of the same material used to form the emission layer 48 of the cover 4, or it may be a different material without departing from the concept described herein. Advantageously, the secondary emission layer 152 has an emissivity value that is even greater than that of the emission layer 148 which, as can be understood from the foregoing, is greater than that of the first surface 132. By way of example, the secondary emission layer 152 may be in the form of a coating of a ceramic material such as ITC 296A manufactured by International Technical Ceramics, Inc., of Jacksonville, Fla., which is known to have an emissivity value greater than that of ITC 213. It is noted that ITC 213 is generally better suited than ITC 296A to be coated onto a metal, thus the ITC 213 is provided as an intermediary layer between the support 116 and the ITC 296A. Another option is to use a single emission layer designed for installation on metal which has an emissivity value equal to or greater than that of ITC 296A, such as ENCOAT M manufactured by North American Refractories of Coraopolis, Pa., USA, which would make the cover 104 in such a scenario similar to the cover 4.

While the cover 4 and the cover 104 can be employed with any type of furnace 8, they are most desirably used with a furnace 8 that does not employ fossil fuels for heating and rather employs electricity or another heat source that does not cause oxidation, corrosion, or other destruction of the second surface 36. While the cover 4 certainly can be employed in fossil fuel fired furnaces 8, and would still provide improvements in cost due to improved heating and reduced material costs, its lifespan may be similar to that of other covers that employ only a support without an emission apparatus.

Advantageously, therefore, a third embodiment of a cover 204 in accordance with the disclosed and claimed concept is depicted generally in FIG. 3B as comprising an emission apparatus 220 that includes an emission layer 248 on the first surface 232 as well as another emission layer 256 disposed on the second surface 236. The emission layer 248 and the another emission layer 256 may be formed of the same material or different materials without departing from the present concept. Advantageously, the emission layer 248 has an emissivity value greater than the emissivity value of the first surface 232, and the another emission layer 256 likewise has an emissivity value greater than that of the second surface 236. By providing the another emission layer 256 on the second surface 236, the cover 204 can be employed in a fossil fired furnace without the risk of causing corrosion of the metal of the underlying support 216.

It is noted, however, that the another emission layer 256 on the second surface 236 that faces generally toward the furnace 8 will resist heating of the cover 204 because of its emissivity value being relatively higher than that of the first surface 232. As such, the furnace that heats the cover 204 will need to be heated to a temperature relatively greater than the temperature used in conjunction with either the cover 4 or the cover 104. However, since the radiation from the emission layer 248 on the first surface 232 is greater than that of the first surface 232 itself, such greater radiation from the emission layer 248 will compensate for the resistance to heating that is caused by the another emission layer 256. That is, while the another emission layer 256 will resist heating by the furnace 8, thus requiring the furnace 8 to be operated at a relatively higher temperature than would be required in the absence of the another emission layer 256, the presence of the emission layer 248 correspondingly increases the radiation from the cover 204 into the workpiece 12, with the result that the furnace 8 typically will at most need to be heated to the same temperature as would be required if the cover were devoid of the emission apparatus 220.

However, the result of heating such a furnace 8 to the same temperature as would be required if the cover 204 were devoid of the emission apparatus 220 nevertheless results in the support 216 itself being at a relatively lower temperature than would be the case if the cover 216 were employed in the same furnace without the emission apparatus 220. That is, in a given furnace 8 at a given temperature, the support 216 by itself would reach a steady state of a given temperature and would radiate into the workpiece a given amount of heat. However, with the addition of the emission apparatus 220 that includes the emission layer 248 and the another emission layer 256 on the second and first surfaces 236 and 232, respectively, the same amount of heat can be radiated into the workpiece, but the support 216 in such a scenario is at a relatively lower steady state temperature than it would be in the absence of the emission apparatus 220.

As such, the support 216 of the cover 204 can be formed of a relatively less expensive material than would be required in the absence of the emission apparatus 220. For example, the cover 216 could be formed of 309 stainless steel rather than Inconel, with significant cost savings. Moreover, the another emission layer 256 on the second surface 236 of the cover 204 shields the support 216 from oxidation, corrosion, etc. in the fossil fueled environment of a furnace. Since the cover 204 is not subject to such degradation, the service life of such a cover 204 is far greater than what would be possible in the absence of the emission apparatus 220. Thus cost savings are possible with the cover 204 due to the usability of a relatively less expensive material for the support 216 as well as the extended service life of the cover 204.

A fourth embodiment of the cover 304 is indicated generally in FIG. 3C and is depicted as including an emission apparatus 320 that includes two emission layers on one of the surfaces of the cover 304 and a single emission layer on the opposite surface of the cover 304. That is, the emission apparatus 320 comprises an emission layer 348 on the first surface 332 and a secondary emission layer 352 on the emission layer 348. The emission apparatus 320 further comprises another emission layer 356 on the second surface 336. The secondary emission layer 352 has an emissivity value greater than that of the emission layer 348 which, in turn, is greater than the emissivity value of the first surface 332. The another emission layer 356 has an emissivity value greater than that of the second surface 336. The cover 304 thus provides a very high degree of emissivity while still protecting from corrosion the support 316.

It should be apparent from the cover 304 and the other embodiments herein that additional configurations of a cover in accordance with the disclosed and claimed concept other than those expressly set forth herein can be developed. For instance, a secondary emission layer can be added to the another emission layer 356 of the cover 304. Other combinations will be apparent to those skilled in the art.

While specific embodiments of the disclosed and claimed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed and claimed concept which is to be given the full breadth of the claims appended and any and all equivalents thereof.

What is claimed is:

1. A cover structured to be disposed between the furnace and a workpiece to at least partially enclose the workpiece during a heating operation performed on the workpiece by the furnace, the cover comprising:
a support having a first surface that has an emissivity value and that is disposed adjacent and facing generally toward the workpiece; and
an emission apparatus comprising an emission layer disposed on the first surface and having an emissivity value greater than that of the first surface.

2. The cover of claim 1 wherein the emission layer is a ceramic coating applied to the first surface.

3. The cover of claim 1 wherein the emission apparatus further comprises an additional emission layer disposed on the emission layer and having an emissivity value greater than that of the emission layer.

4. The cover of claim 3 wherein the emission layer is a ceramic coating applied to the first surface, and wherein the additional emission layer is a ceramic coating applied to the emission layer.

5. The cover of claim 1 wherein the support further comprises a second surface that has an emissivity value and that is disposed adjacent and facing generally toward the furnace, and wherein the emission apparatus further comprises another emission layer disposed on the second surface and having an emissivity value greater than that of the second surface.

6. The cover of claim 5 wherein the emission apparatus further comprises an additional emission layer disposed on the emission layer and having an emissivity value greater than that of the emission layer

7. A method of performing a heating operation on a workpiece with a furnace, the method comprising:
at least partially enclosing the workpiece within a cover that is disposed between the workpiece and the furnace, the cover comprising:
a support having a first surface that has an emissivity value and that is disposed adjacent and facing generally toward the workpiece, and
an emission apparatus comprising an emission layer disposed on the first surface and having an emissivity value greater than that of the first surface; and
operating the furnace at a given temperature range for a given period of time.

8. The method of claim 7 wherein the at least partially enclosing of the workpiece within a cover comprises at least partially enclosing the workpiece within a cover wherein the emission layer is a ceramic coating applied to the first surface.

9. The method of claim 7 wherein the at least partially enclosing of the workpiece within a cover comprises at least partially enclosing the workpiece within a cover wherein the emission apparatus further comprises an additional emission layer disposed on the emission layer and having an emissivity value greater than that of the emission layer.

10. The method of claim 9 wherein the at least partially enclosing of the workpiece within a cover further comprises at least partially enclosing the workpiece within a cover wherein the emission layer is a ceramic coating applied to the first surface, and wherein the additional emission layer is a ceramic coating applied to the emission layer.

11. The method of claim 7 wherein the at least partially enclosing of the workpiece within a cover comprises at least partially enclosing the workpiece within a cover wherein the support further comprises a second surface that has an emissivity value and that is disposed adjacent and facing generally toward the furnace, and wherein the emission apparatus further comprises another emission layer disposed on the second surface and having an emissivity value greater than that of the second surface.

12. The method of claim 11 wherein the at least partially enclosing of the workpiece within a cover further comprises at least partially enclosing the workpiece within a cover wherein the emission apparatus further comprises an additional emission layer disposed on the emission layer and having an emissivity value greater than that of the emission layer.

13. A method of retrofitting a furnace with a cover that is structured to be disposed between the furnace and a workpiece to at least partially enclose the workpiece during a heating operation performed on the workpiece by the furnace, the method comprising:
removing a cover that is substantially free of ceramic coatings;
installing a cover that comprises a support and an emission apparatus;
the support having a first surface that has an emissivity value and that is disposed adjacent and facing generally toward the workpiece; and
the emission apparatus comprising an emission layer disposed on the first surface and having an emissivity value greater than that of the first surface.

14. The method of claim 13 wherein the installing of the cover comprises installing a cover wherein the emission layer is a ceramic coating applied to the first surface.

15. The method of claim 13 wherein the installing of the cover comprises installing a cover wherein the emission apparatus further comprises an additional emission layer disposed on the emission layer and having an emissivity value greater than that of the emission layer.

16. The method of claim 15 wherein the installing of the cover comprises installing a cover wherein the emission layer is a ceramic coating applied to the first surface, and wherein the additional emission layer is a ceramic coating applied to the emission layer.

17. The method of claim 13 wherein the installing of the cover comprises installing a cover wherein the support further comprises a second surface that has an emissivity value and that is disposed adjacent and facing generally toward the furnace, and wherein the emission apparatus further comprises another emission layer disposed on the second surface and having an emissivity value greater than that of the second surface.

18. The method of claim 17 wherein the installing of the cover comprises installing a cover wherein the emission apparatus further comprises an additional emission layer disposed on the emission layer and having an emissivity value greater than that of the emission layer.
